(19) United States
(12) Patent Application Publication
(10) Pub. No.: US 2024/0220089 A1
(43) Pub. Date: Jul. 4, 2024

(54) VIEW DISPLAYING METHOD AND DEVICE, AND MEDIUM

(71) Applicant: Beijing Zitiao Network Technology Co., Ltd., Beijing (CN)

(72) Inventors: Shiqi WAN, BEIJING (CN); Hongxiao XIN, BEIJING (CN)

(21) Appl. No.: 18/556,278

(22) PCT Filed: Apr. 26, 2022
(86) PCT No.: PCT/CN2022/089319

§ 371 Date: Oct. 19, 2023

(30) Foreign Application Priority Data
May 10, 2021 (US) 202110505787.7

(51) Int. Cl. G06F 3/0484; G06F 3/0481; G06F 40/103

(52) U.S. Cl. CPC G06F 3/0484; G06F 3/0481; G06F 40/103; G06F 2203/04806

(57) ABSTRACT

The present disclosure provides a view displaying method, device and medium, the method including: displaying a content area and a view area in a document interface, wherein the view area is used for displaying one or more pieces of view information; and in response to a browse triggering operation on view information in the view area, displaying the view information in the view area in a first browse direction, wherein the content area corresponds to a second browse direction different from the first browse direction.

### CROSS-REFERENCE TO RELATED APPLICATIONS

The present disclosure is a U.S. National Stage Application under 35 U.S.C. § 371 of International Patent Application No. PCT/CN2022/089319, filed on Apr. 26, 2022, which is based on and claims the priority to the Chinese patent application No. 202110505787.7 filed on May 10, 2021, the disclosure of both of which are incorporated herein by reference in its entirety.

### TECHNICAL FIELD

The present disclosure relates to the technical field of information processing, and in particular, to a view displaying method, apparatus, device and medium.

### BACKGROUND

A view usually comprises one or more pieces of view information, each of which can carry different contents, and through which main information can be visually presented to a user.

With the development of information technology, the user can browse document information conveniently and quickly.

### SUMMARY

To solve the above technical problems, or at least partially solve the above technical problems, the present disclosure provides a view displaying method, apparatus, device, and medium.

In a first aspect, the present disclosure provides a view displaying method, comprising: displaying a content area and a view area in a document interface, wherein the view area is used for displaying one or more pieces of view information; and in response to a browse triggering operation on view information in the view area, displaying the view information in the view area in a first browse direction, wherein the content area corresponds to a second browse direction different from the first browse direction.

In some embodiments, the method comprises: in response to portrait-screen viewing of the document interface, matching a number of pieces of the view information displayed in the view area with a portrait-screen displaying size of the view area; and in response to landscape-screen viewing of the document interface, matching the number of pieces of the view information displayed in the view area with a landscape-screen displaying size of the view area.

In some embodiments, the in response to a browse triggering operation on the view information in the view area, displaying in the view area, rest view information in the view, comprises: in response to a leftward/rightward swipe browsing operation on the view information in the view area, leftward/rightward swiping in the view area, to display the rest view information in the view.

In some embodiments, the in response to a browse triggering operation on view information in the view area, displaying in the view area, rest view information in the view, comprises: in response to a triggering operation on a browse control of the view information in the view area, updating and displaying, in the view area, the rest view information in the view.

In some embodiments, the method further comprises: in response to a triggering operation on a control in the view area, adjusting the first browse direction of the view information to the second browse direction, and/or adjusting layout information of the view information from first layout information to second layout information, the layout information comprising at least one of a position relation between the pieces of view information or a position relation between the pieces of view information and the control.

In some embodiments, the method further comprises: in response to a zoom-in triggering operation on the view information in the view area, displaying, in a full-screen area, the one or more pieces of view information in the view.

In some embodiments, the zoom-in triggering operation on the view information in the view area comprises: performing a triggering operation on a zoom-in control associated with the view area in the document interface; or performing a double-click operation on the view area.

In some embodiments, the method comprises: in response to portrait-screen viewing of the document interface, matching a number of pieces of the view information displayed in the full-screen area with the portrait-screen displaying size; and in response to landscape-screen viewing of the document interface, matching a number of pieces of the view information displayed in the full-screen area with the landscape-screen displaying size.

In some embodiments, the method further comprises: in response to a browse triggering operation on the view information in the full-screen area, displaying the view information in the full-screen area in the second browse direction.

In some embodiments, the in response to a browse triggering operation on the view information in the full-screen area, displaying the rest view information in the view in the full-screen area, comprises: in response to an upward/downward swipe browsing operation on the view information in the full-screen area, upward/downward swiping in the full-screen area, to display the rest view information in the view.

In some embodiments, the in response to a browse triggering operation on the view information in the full-screen area, displaying the rest view information in the view in the full-screen area, comprises: in response to a triggering operation on a browse control of the view information in the full-screen area, updating and displaying, in the full-screen area, the rest view information in the view.

In some embodiments, the method further comprises: in response to a triggering operation on a control in the full-screen area, adjusting the second browse direction of the view information to the first browse direction, and/or adjusting a key content of the view information from first displaying information to second displaying information, the key content comprising at least one of an image content of the view information or a text content of the view information.

In some embodiments, the method further comprises: in response to a viewing operation on target view information, performing full-screen display on the target view information; and in response to a triggering operation on a target function entry on the target view information, starting the target function.

In a second aspect, the present disclosure further provides a view displaying apparatus, comprising: a first display module configured to display a content area and a view area in a document interface, wherein the view area is used for displaying one or more pieces of view information; and a first presentation module configured to, in response to a browse triggering operation on view information in the view area, present the view information in the view area in a first browse direction, wherein the content area corresponds to a second browse direction different from the first browse direction.

In a third aspect, the present disclosure provides a non-transitory computer-readable storage medium having therein stored instructions which, when running on a terminal device, cause the terminal device to implement the above method.

In a fourth aspect, the present disclosure provides an electronic device, comprising: a processor; and a memory configured to store executable instructions for the processor, wherein the processor is configured to read the executable instructions from the memory and execute the instructions to implement the above method.

In a fifth aspect, the present disclosure provides a computer program product, comprising a computer program/instructions which, when executed by a processor, implements the above method.

In a sixth aspect, the present disclosure provides a computer program, comprising instructions which, when executed by a processor, cause the processor to perform the above view displaying method.

### BRIEF DESCRIPTION OF THE DRAWINGS

The above and other features, advantages, and aspects of embodiments of the present disclosure will become more apparent by referring to the following DETAILED DESCRIPTION when taken in conjunction with the accompanying drawings. Throughout the drawings, identical or similar reference numbers denote identical or similar elements. It should be understood that the drawings are schematic and that components and elements are not necessarily drawn to scale.

FIG. 1 is a schematic flow diagram of a view displaying method provided in some embodiments of the present disclosure.

FIG. 2a is a schematic interface diagram of view displaying provided in some embodiments of the present disclosure.

FIG. 2b is a schematic interface diagram of another view displaying provided in some embodiments of the present disclosure.

FIG. 2c is a schematic interface diagram of yet another view displaying provided in some embodiments of the present disclosure.

FIG. 3 is a schematic interface diagram of yet another view displaying provided in some embodiments of the present disclosure.

FIG. 4a is a schematic interface diagram of yet another view displaying provided in some embodiments of the present disclosure.

FIG. 4b is a schematic interface diagram of yet another view displaying provided in some embodiments of the present disclosure.

FIG. 4c is a schematic interface diagram of yet another view displaying provided in some embodiments of the present disclosure.

FIG. 4d is a schematic interface diagram of yet another view displaying provided in some embodiments of the present disclosure.

FIG. 5a is a schematic interface diagram of yet another view displaying provided in some embodiments of the present disclosure.

FIG. 5b is a schematic interface diagram of yet another view displaying provided in some embodiments of the present disclosure.

FIG. 6 is a schematic flow diagram of another view displaying method provided in some embodiments of the present disclosure.

FIG. 7a is a schematic interface diagram of yet another view displaying provided in some embodiments of the present disclosure.

FIG. 7b is a schematic interface diagram of yet another view displaying provided in some embodiments of the present disclosure.

FIG. 8 is a schematic interface diagram of yet another view displaying provided in some embodiments of the present disclosure.

FIG. 9a is a schematic interface diagram of yet another view displaying provided in some embodiments of the present disclosure.

FIG. 9b is a schematic interface diagram of yet another view displaying provided in some embodiments of the present disclosure.

FIG. 10 is a schematic flow diagram of yet another view displaying method provided in some embodiments of the present disclosure.

FIG. 11 is a schematic structural diagram of a view displaying apparatus provided in some embodiments of the present disclosure.

FIG. 12 is a schematic structural diagram of an electronic device provided in some embodiments of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein. On the contrary, these embodiments are provided for a more complete and thorough understanding of the present disclosure. It should be understood that the drawings and the embodiments of the present disclosure are for exemplary purposes only and are not intended to limit the scope of protection of the present disclosure.

It should be understood that the various steps recited in method embodiments of the present disclosure may be performed in a different order, and/or performed in parallel. Moreover, the method embodiments may comprise additional steps and/or omit performing the illustrated steps. The scope of the present disclosure is not limited in this respect.

The term “comprising” and variations thereof used herein is intended to be open-ended, i.e., “comprising but not limited to”. The term “based on” means “at least partially based on”. The term “one embodiment” means “at least one embodiment”; the term “another embodiment” means “at least one other embodiment”; the term “some embodiments” means “at least some embodiments”. Relevant definitions for other terms will be given in the following description.

It should be noted that the concepts such as “first” and “second” mentioned in the present disclosure are only used for distinguishing different devices, modules or units, but are not used for limiting the order or interdependence of functions performed by the devices, modules or units.

It should be noted that the modifications of “one” or “more” mentioned in the present disclosure are intended to be illustrative rather than restrictive, and that those skilled in the art should appreciate that they should be understood as “one or more” unless otherwise clearly stated in the context.

Names of messages or information exchanged between a plurality of devices in the embodiments of the present disclosure are for illustrative purposes only, and are not intended to limit the scope of the messages or information.

With the development of the information technology, a user can browse document information conveniently and quickly. However, due to limitations in space of a display screen, at present contents contained in the document are mainly text information, and multimedia information in a view cannot be integrated while text displaying is not affected.

In practical applications, in some application scenarios, a view needs to be inserted into a document, however, the space occupied by the view is too large to reduce convenience of viewing other contents of the document.

In order to solve the above problem, some embodiments of the present disclosure provides a view displaying method, which is described below in conjunction with a specific embodiment.

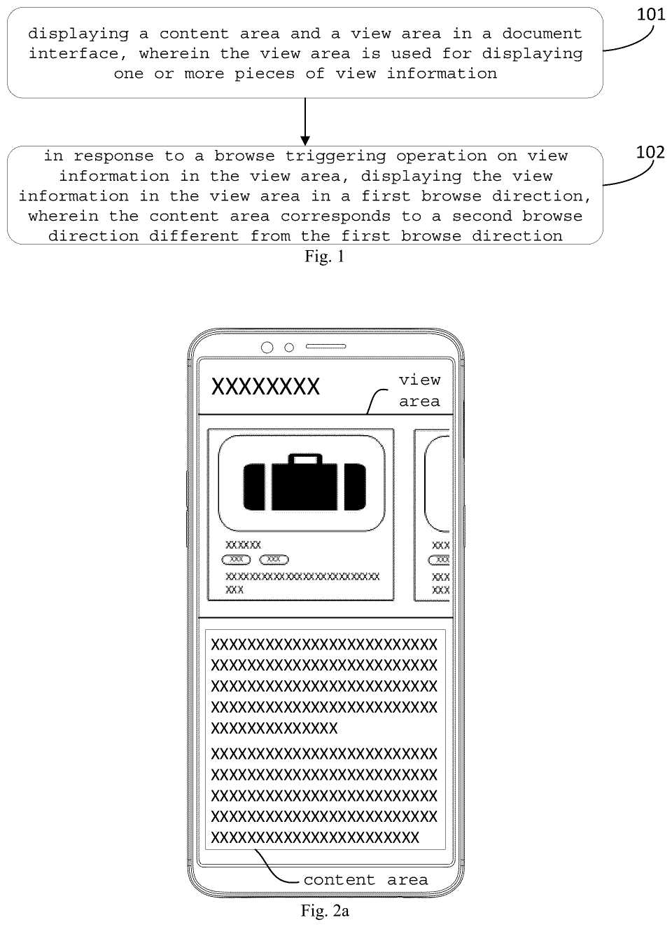

FIG. 1 is a schematic flow diagram of a view displaying method provided in some embodiments of the present disclosure. The method may be executed by a view displaying apparatus, wherein the apparatus may be implemented in software and/or hardware, and may be generally integrated in an electronic device. As shown in FIG. 1, the method comprises: step 101, displaying a content area and a view area in a document interface, wherein the view area is used for displaying one or more pieces of view information.

In some embodiments, there are various application scenarios for the view displaying method of the present disclosure, which are not limited in this embodiment, for example: mobile phone, microcomputer. It should be noted that the document interface in the view displaying method may be used for displaying information, and the document interface may comprise the content area and the view area.

The content area may be used for displaying content information and the content information is various, for example: image, text, and may be selected according to a specific application scenario, which is not limited in this embodiment.

The view area may be used for displaying the view information. In some embodiments of the present disclosure, according to different application scenarios and requirements, the view information in the view area may carry different categories of information, so that the information may, through the view information, be more clearly displayed to a user: for a scenario for image displaying, the information category contained in the view information may be image; and for a scenario for comprehensive multimedia information displaying, the information category contained in the view information may include: image, text, hyperlink. It should be noted that, the above scenarios may be used in combination according to application needs, which is not limited in this embodiment. For the sake of clearer statement, the information carried by the view information in the view is exemplified as follows:

If the view information is used for comprehensive displaying of personnel data, the view information may include: a personnel one-inch photo, a personnel profile, and a personnel homepage. It should be noted that, when there are a plurality of persons, information on the plurality of persons may be entered in a database, and view information for each person may be generated according to the database.

In some embodiments of the present disclosure, the document interface may be an interface of an online document or an interface of an offline document. The view area in the document interface is various, and may be selected according to an application scenario, which is not limited in some embodiments and exemplified as follows.

Example 1: the view area may be one area, and its location includes: upper, middle, and lower parts of the document interface. This is exemplified as follows:

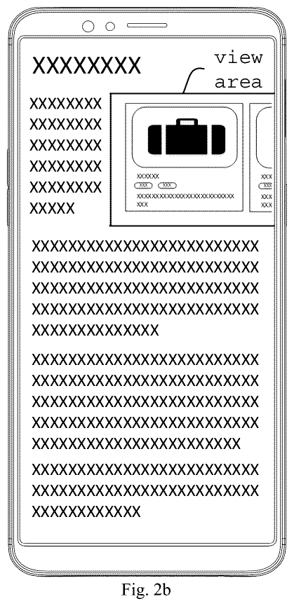

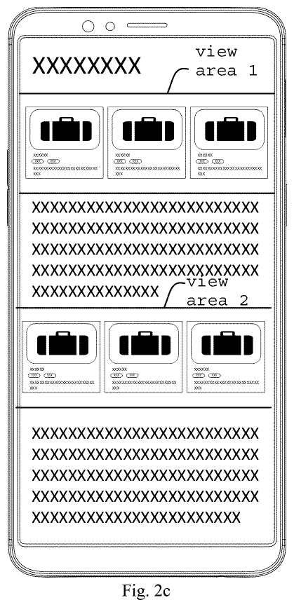

The view area may be as shown in FIG. 2a, which is a schematic interface diagram of view displaying provided in some embodiments of the present disclosure, and in which, the view area runs through the document interface. The content area may be an area in the document interface that does not belong to the view area, or an area as shown in FIG. 2a.

The view area may also be as shown in FIG. 2b, which is a schematic interface diagram of another view displaying provided in some embodiments of the present disclosure, and in which, the view area does not run through the document interface; it can be understood that, when the document interface is larger, the display mode in FIG. 2b may improve convenience of the user's operation on the view area.

Example 2: the view area may be a plurality of areas, which is exemplified as follows:

As shown in FIG. 2c, which is a schematic interface diagram of yet another view displaying provided in some embodiments of the present disclosure, the view area may be two areas, wherein a view area 1 may be located on an upper part of the document interface, and a view area 2 may be located on a lower part of the document interface.

Alternatively, in order to enhance experience of the user, a number of pieces of the view information in the view area may be determined according to a viewing direction of the screen.

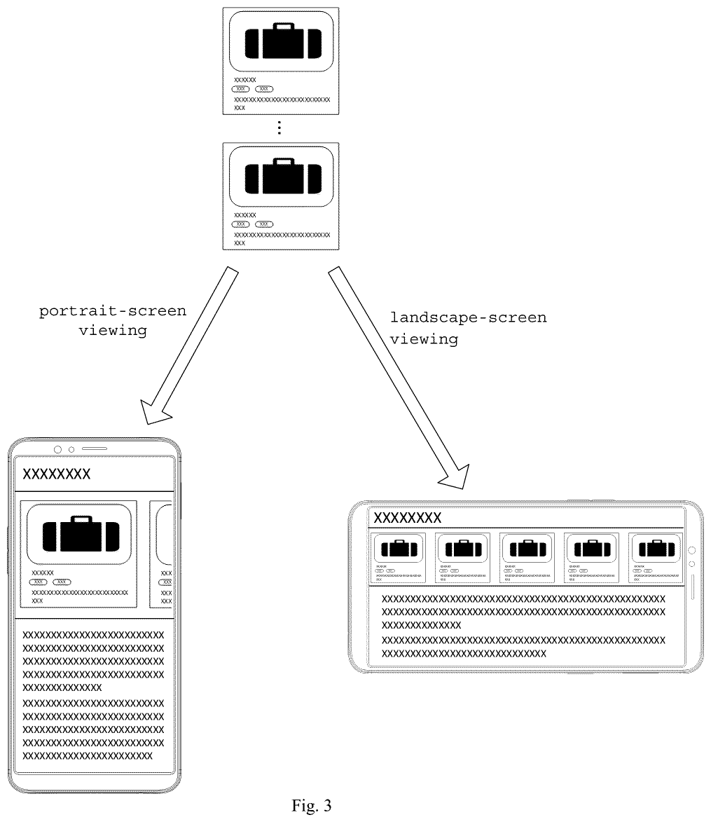

As shown in FIG. 3, which is a schematic interface diagram of yet another view displaying provided in some embodiments of the present disclosure, in general, the viewing direction of the screen includes a portrait screen and a landscape screen.

If the user takes portrait-screen viewing, in response to the portrait-screen viewing of the document interface, a number of pieces of the view information displayed in the view area is matched with a portrait-screen displaying size of the view area.

If the user takes landscape-screen viewing, in response to the landscape-screen viewing of the document interface, a number of pieces of the view information displayed in the view area is matched with a landscape-screen displaying size of the view area.

In some embodiments of the present disclosure, a width of a view area in a landscape-screen scenario is greater than a width of a view area in a portrait-screen scenario, and if the user changes from the portrait-screen viewing to the landscape-screen viewing, the width of the view area is also increased, then the number of pieces of view information displayed in the video area in the case of the landscape screen is greater than the number of pieces of view information displayed in the video area in the case of the portrait screen.

Step 102, in response to a browse triggering operation on view information in the view area, displaying the view information in the view area in a first browse direction, wherein the content area corresponds to a second browse direction different from the first browse direction.

In some embodiments of the present disclosure, the user may perform a triggering operation on the view information in the view area, the triggering operation including, but not limited to: touching the screen and leftward/rightward swiping, triggering any of browse controls. The browse control can be used for controlling display of the view information in the view. The browse control may be located on the document interface, and a position of the browse control may be set according to an application scenario, which is not limited in this embodiment.

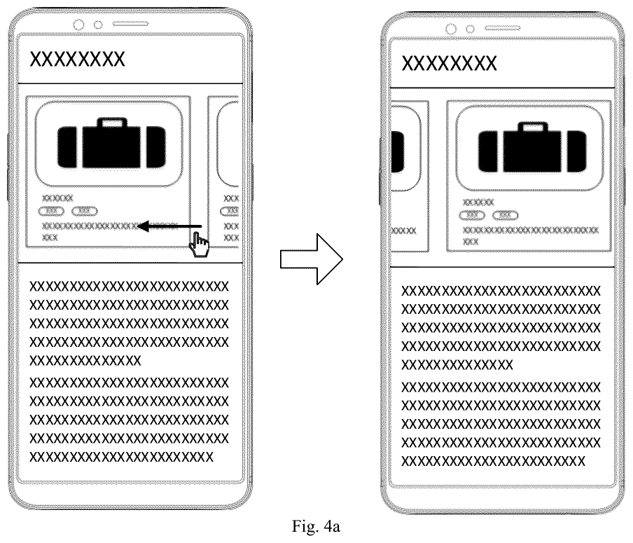

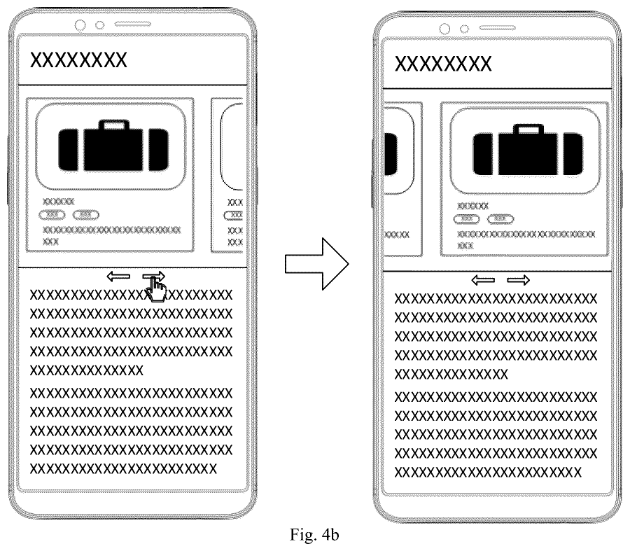

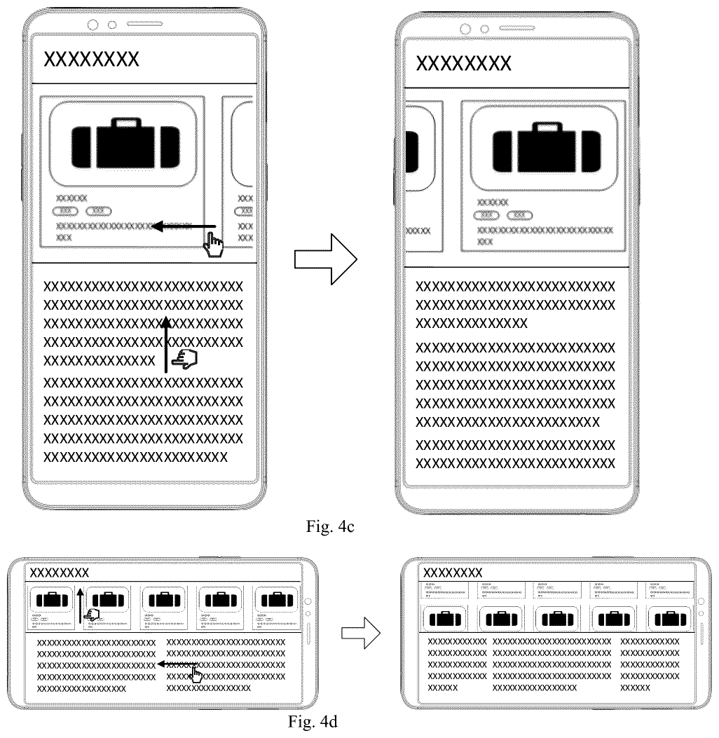

In some embodiments, as shown in FIG. 4a, which is a schematic interface diagram of yet another view displaying provided in some embodiments of the present disclosure, the triggering operation of the user is a leftward swipe browsing operation on the view information in the view area, and in response to the leftward swipe browsing operation on the view information in the view area, leftward swipe in the view area to display rest view information in the view. It can be understood that, if the triggering operation of the user is a rightward swipe browsing operation on the view information in the view area, in response to the rightward swipe browsing operation on the view information in the view area, rightward swipe in the view area to display rest view information in the view.

In some embodiments, as shown in FIG. 4b, which is a schematic interface diagram of yet another view displaying provided in some embodiments of the present disclosure, the browse control is virtual keys in a style of leftward and rightward arrows, the triggering operation of the user is a triggering operation on a browse control of the view information in the view area, and in response to the triggering operation on a browse control of the view information in the view area, update and display, in the view area rest view information in the view. The update includes but is not limited to: swiping update, refreshing update.

It should be noted that a displaying direction of the view information corresponding to the view area may be the first browse direction, and a displaying direction corresponding to the content area may be the second browse direction, wherein the first browse direction is different from the second browse direction. A combination of the first browse direction and the second browse direction may be various, which is not limited in some embodiments and exemplified as follows.

As shown in FIG. 4c, which is a schematic interface diagram of yet another view displaying provided in some embodiments of the present disclosure, in the case of portrait-screen viewing, the first browse direction is a horizontal direction, and the second browse direction is a vertical direction. The user can perform browse trigger in the view area in the first browse direction, and perform brows trigger in the content area in the second browse direction. According to the view displaying method of this embodiment, in response to the triggering operation of the user, the view information is displayed in the view area in the first browse direction, and the content information is displayed in the content area in the second browse direction.

As shown in FIG. 4d, which is a schematic interface diagram of yet another view displaying provided in some embodiments of the present disclosure, in the case of landscape-screen viewing, the first browse direction is a vertical direction, and the second browse direction is a horizontal direction. The user can perform browse trigger in the view area in the first browse direction, and perform browse trigger in the content area in the second browse direction. According to the view displaying method of this embodiment, in response to the triggering operation of the user, the view information is displayed in the view area in the first browse direction, and the content information is displayed in the content area in the second browse direction.

In some embodiments of the present application, there may be a control in the view area, which may be used for switching a browse mode of the view information. The user may trigger the control, and in response to a triggering operation on the control in the view area, there are various switchable browse modes of the view information, which is not limited in some embodiments and exemplified as follows.

In some embodiments, in response to the triggering operation on the control in the view area, the first browse direction of the view information may be adjusted to the second browse direction.

For example, the first browse direction of the view information in the view area is a horizontal direction, the second browse direction corresponding to the content area is a vertical direction, and the user triggers the control in the view area, so that the browse direction of the view information is adjusted to the second browse direction, namely the vertical direction.

In some embodiments, in response to the triggering operation on the control in the view area, layout information of the view information may be adjusted from first layout information to second layout information, the layout information comprising at least one of a position relation between the pieces of view information or a position relation between the pieces of view information and the control.

The layout information comprises: at least one of a position relation between the pieces of view information or a position relation between the pieces of view information and the control. Therefore, a difference between the first layout information and the second layout information includes: at least one of different position relations between the pieces of view information or different position relations between the pieces of view information and the control.

A combination of the first layout information and the second layout information is various, which is not limited in some embodiments and exemplified as follows.

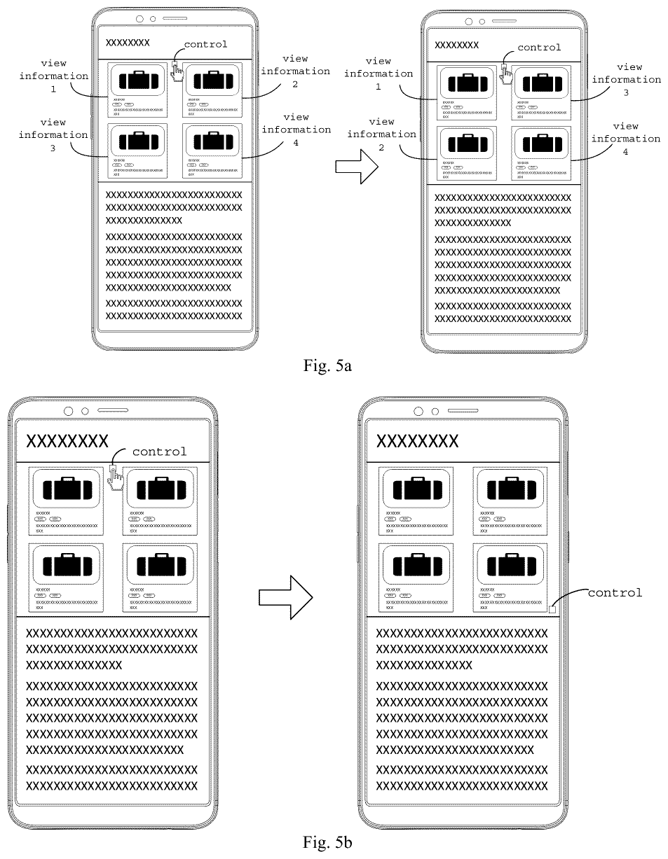

As shown in FIG. 5a, it is a schematic interface diagram of yet another view displaying provided in some embodiments of the present disclosure. In the first layout information, the view information is arranged in a horizontal direction; and in the second layout information, the view information is arranged in a vertical direction. In response to the triggering operation on the control in the view area, the first layout information is adjusted to the second layout information.

As shown in FIG. 5b, it is a schematic interface diagram of yet another view displaying provided in some embodiments of the present disclosure. In the first layout information, the control is located in the upper middle of the view area; and in the second layout information, the control is located in a lower right part of the view area. In response to the triggering operation on the control in the view area, the first layout information is adjusted to the second layout information.

It may be understood that, in some embodiments of the present application, in response to the triggering operation on the control in the view area, the first browse direction of the view information may be adjusted to the second browse direction, and the layout information of the view information may be adjusted from the first layout information to the second layout information.

By triggering the control in the view area, customization of the view displaying can be implemented, so that the view displaying method more meets a habit of the user, which enhances user experience.

According to the view displaying method of the embodiments of the present disclosure, the document comprises the content area and the view area. The view information in the view is displayed in the view area, so that the view information occupying too much space of the document interface is avoided, and the user is enabled to view the context of the document while browsing the view information; the user can browse the rest view information of the view through the triggering operation, thereby ensuring integrity of the information while saving the space of the document interface.

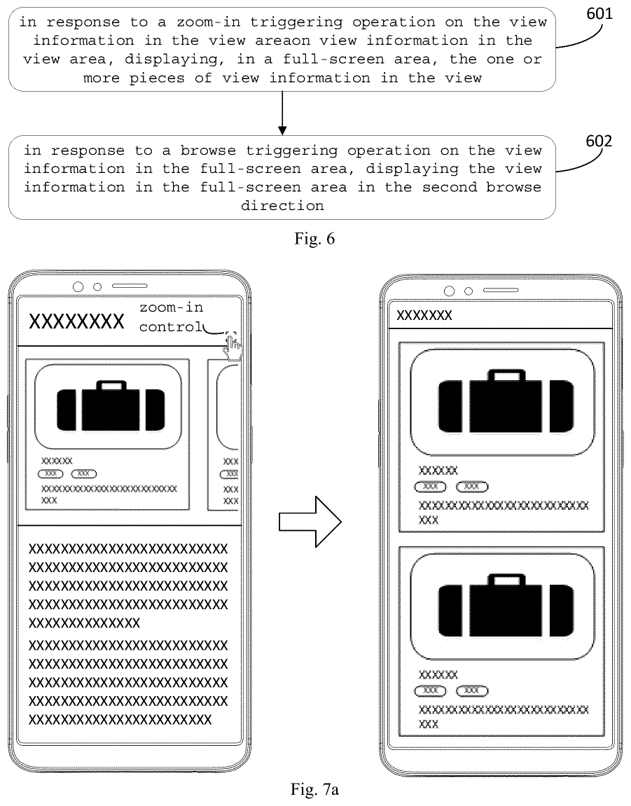

In some embodiments of the present disclosure, based on the above embodiments, in order to more clearly display the view information, the view information in the view area may be displayed in a full screen. Alternatively, as shown in FIG. 6, it is a schematic flow diagram of another view displaying method provided in some embodiments of the present disclosure, and the embodiments of the present disclosure may further comprise: step 601, in response to a zoom-in triggering operation on the view information in the view area, displaying, in a full-screen area, the one or more pieces of view information in the view.

In some embodiments of the present disclosure, the view information may be displayed in a full screen, and the user may perform a triggering operation on the view information in the view area. The triggering operation is various, and may be selected according to different application scenarios, which is exemplified as follows.

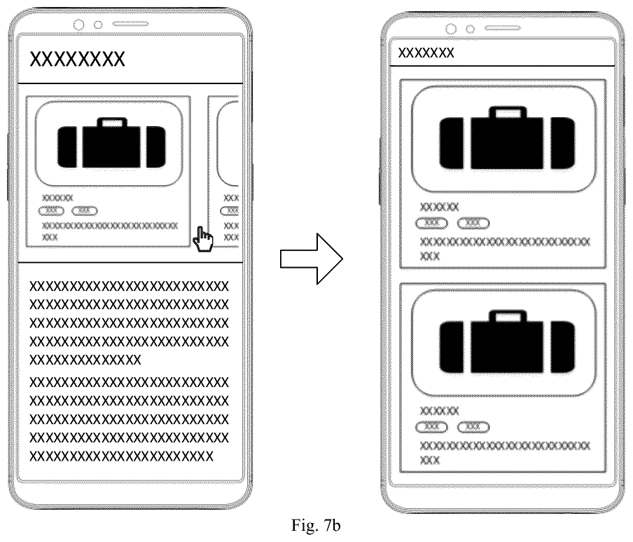

As shown in FIG. 7a, which is a schematic interface diagram of yet another view displaying provided in some embodiments of the present disclosure, the triggering operation may be a triggering operation on a zoom-in control associated with the view area in the document interface. It can be understood that a position and style of the zoom-in control may be set according to an application scenario, which is not limited in this embodiment, for example: the zoom-in control may be in a style of text and located at a lower part of the document interface, the zoom-in control may be in a style of a virtual key and located at an upper part of the document interface.

As shown in FIG. 7b, which is a schematic interface diagram of yet another view displaying provided in some embodiments of the present disclosure, the triggering operation may be a double-click operation on the view area. The double-click operation may be implemented by touching the screen, and if the view displaying method is applied to a microcomputer, the double-click operation may also be implemented by a mouse.

The triggering operation may be a long press on the view information in the view area, wherein the long press operation may be implemented by a mouse or by touching the screen.

According to the view displaying method of some embodiments, in response to the zoom-in triggering operation on the view information in the view area, the one or more pieces of view information in the view is displayed in the full-screen area. The method of displaying in the full-screen area can comprise: displaying, in the document interface, the one or more pieces of view information in the view without displaying other contents of the document; and displaying, in the document interface, the one or more pieces of view information in the view, and displaying key information of the document, the key information including but not limited to: a document title, and a document author.

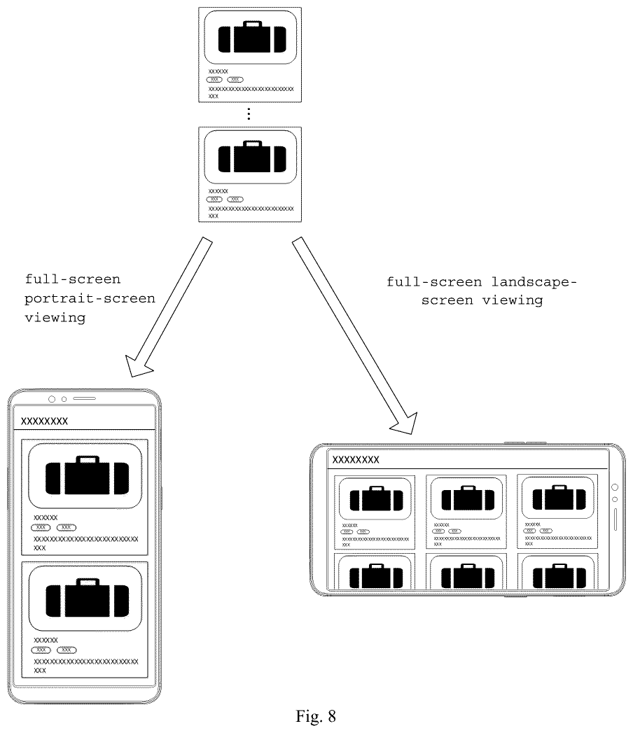

Alternatively, a number of pieces of the view information displayed in the full-screen area may be related to a viewing mode, as shown in FIG. 8, which is a schematic interface diagram of yet another view displaying provided in some embodiments of the present disclosure.

If the viewing mode of the user is portrait screen, in response to portrait-screen viewing of the document interface, a number of pieces of the view information displayed in the full-screen area is matched with the portrait-screen displaying size.

If the viewing mode of the user is landscape screen, in response to landscape-screen viewing of the document interface, a number of pieces of the view information displayed in the full-screen area is matched with the landscape-screen displaying size.

In some embodiments of the present disclosure, a width of a full-screen area in a landscape-screen scenario is greater than a width of a full-screen area in a portrait-screen scenario, and if the user changes from the portrait-screen viewing to the landscape-screen viewing, the width of the full-screen area is also increased, then the number of pieces of the view information displayed in the video area in the case of landscape screen is greater than the number of pieces of the view information displayed in the video area in the case of portrait screen.

Step 602, in response to a browse triggering operation on the view information in the full-screen area, displaying the view information in the full-screen area in the second browse direction.

In some embodiments of the present disclosure, the user may perform a triggering operation on the view information in the full-screen area, the triggering operation including, but not limited to: touching the screen and clicking, triggering any of browse controls. The browse control can be used for controlling display of the view information in the view. The browse control may be located on the document interface, and a position of the browse control may be set according to an application scenario, which is not limited in this embodiment. In response to the triggering operation, a browse direction of the full-screen area may be the second browse direction, wherein the second browse direction includes a vertical direction.

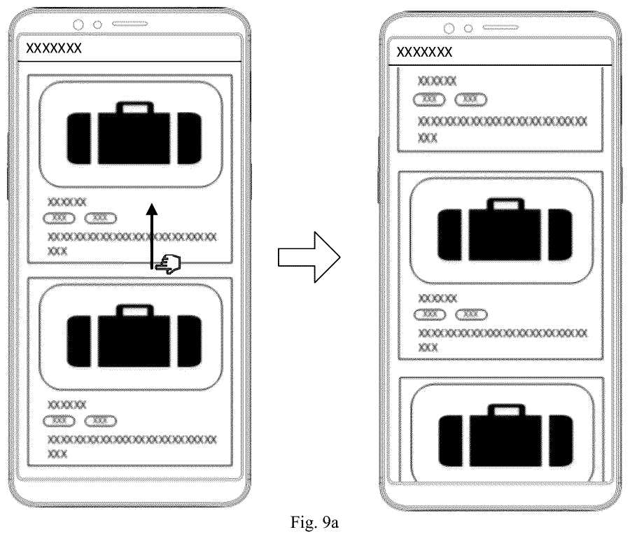

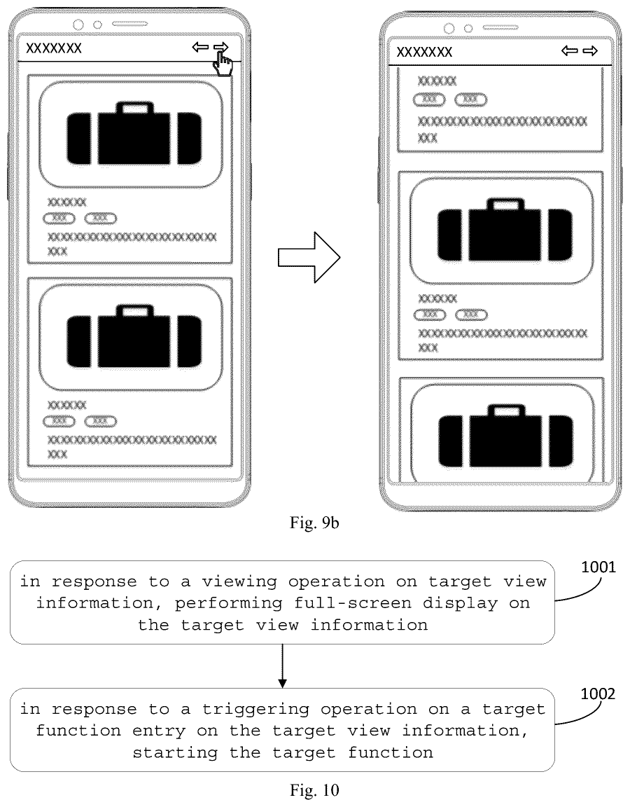

In some embodiments, as shown in FIG. 9a, which is a schematic interface diagram of yet another view displaying provided in some embodiments of the present disclosure, the triggering operation of the user is an upward swipe browsing operation on the view information in the full-screen area, and in response to the upward swipe browsing operation on the view information in the full-screen area, upward swipe in the full-screen area to present rest view information in the view. It can be understood that, if the triggering operation of the user is a downward swipe browsing operation on the view information in the full-screen area, in response to the downward swipe browsing operation on the view information in the full-screen area, downward swipe in the full-screen area to display rest view information in the view.

In some embodiments, as shown in FIG. 9b, which is a schematic interface diagram of yet another view displaying provided in some embodiments of the present disclosure, the browse control is virtual keys that are leftward and rightward arrows. The leftward arrow may be used for controlling upward update of the view information in the full-screen area; and the rightward arrow may be used for controlling downward update of the view information in the full-screen area. The triggering operation of the user is a triggering operation on a browse control of the view information in the full-screen area, and in response to the triggering operation on a browse control of the view information in the full-screen area, update and display, in the full-screen area, rest view information in the view. The update includes but is not limited to: swiping update and refreshing update.

In some embodiments of the present application, there may be a control in the full-screen area, which may be used for switching a browse mode of the view information and/or a key content of the view information. The user may trigger the control, and in response to the triggering operation on the control in the full-screen area, the switchable browsing mode of the view information and/or the key content of the view information are various, which are not limited in some embodiments and exemplified as follows.

In some embodiments, in response to the triggering operation on the control in the full-screen area, the second browse direction of the view information may be adjusted to the first browse direction.

For example: a first browse direction of view information in the view area is a horizontal direction, a second browse direction corresponding to the content area is a vertical direction, and a user triggers the control in the view area, so that the browse direction of the view information is switched to the first browse direction, namely the horizontal direction.

Generally speaking, the view area is less than the full-screen area, so that in the case where the view information is displayed in the full-screen area, the content included in the view information may correspondingly change. In some embodiments, in response to the triggering operation on the control in the full-screen area, the key content of the view information may be adjusted from first displaying information to second displaying information, wherein the key content includes at least one of an image content of the view information or a text content of the view information.

An image size of an image content in the second displaying information may be greater than an image size of an image content in the first displaying information.

A text content of the second display information may be richer than that of the first display information. For example, in the case where the view information is information related to an itinerary, the first displaying information may include: itinerary description, start and end dates. The second displaying information may include: itinerary description, start and end dates, tour guides, planning departments, and related data.

In some embodiments, in response to the triggering operation on the control in the full-screen area, the second browse direction of the view information is adjusted to the first browse direction, and the key content of the view information is adjusted from the first displaying information to the second displaying information.

By triggering the control in the full-screen area, customization of the view displaying can be implemented, so that the view displaying method more meets a habit of the user, which enhances user experience.

According to the view displaying method of the embodiments of the present disclosure, the one or more pieces of view information in the view can be displayed in the full-screen area, and the user is enabled to browse the view information more clearly; moreover, the operation is simple, and zoom-in of all the view information can be implemented through one triggering operation, which enhances user experience and makes the operation of the user more convenient. The user can also perform the browse triggering operation on the view information in the full-screen area, and through the operation, the user can acquire more comprehensive information.

In embodiments of the present disclosure, based on the above embodiment, a viewing operation may be further performed on the view information. Alternatively, as shown in FIG. 10, is a schematic flow diagram of yet another view displaying method provided in some embodiments of the present disclosure, and the embodiments of the present disclosure may further comprise: step 1001, in response to a viewing operation on target view information, performing full-screen display on the target view information.

In some embodiments of the present disclosure, the user may perform the viewing operation on the target view information. The viewing operation is various, and may be selected according to an application scenario, which is not limited in this embodiment. For example: dragging the target view information, a double-finger zoom-in operation on the target view information. In response to the viewing operation on the target view information, full-screen display on the target view information may be performed in the document interface.

In some embodiments, the target view information may be one piece of view information, then the target view information in the full-screen display is also the one piece of view information.

Step 1002, in response to a triggering operation on a target function entry on the target view information, starting the target function.

In some embodiments of the present disclosure, there may be a target function entry on the target view information. The target function may be set according to the target view information, which is not limited in this embodiment, for example: if the target view information is video introduction view information, the target function may be a video playing function; and if the target view information is commodity introduction view information, the target function may be a shopping page jump function.

The target function entry may be various, and may be set according to a specific application scenario, which is not limited in some embodiments and exemplified as follows.

The target function entry is a specific area in the view information, so that the user can start the target function by triggering the specific area in the view information. The specific area includes, but is not limited to: if the target view information is video introduction view information, a playing key for a video being the specific area; and if the target view information is commodity introduction view information, jump prompt text in the shopping page being the specific area. The triggering operation on the specific area includes, but is not limited to: single click, long press.

The target function entry is a specific area in the document interface, so that the user can start the target function by triggering the specific area in the document interface.

According to the view displaying method of the embodiments of the present disclosure, viewing on the target view information may be performed in a full screen, and the corresponding target function can be started, so that the content of the view displaying is enriched, experience of the user is enhanced, and fun is boosted when the user browses the view information in the view.

Compared with the related art, the technical solution provided in the embodiments of the present disclosure has at least the following advantages.

According to the view displaying method provided in the embodiments of the present disclosure, the view information in the view is displayed in the view area, so that the view information occupying too much space of the document interface is avoided, the user is enabled to view the context of the document while browsing the view information, and the user can browse the rest view information of the view through the triggering operation, so that convenience of the user viewing the document is improved, and integrity of the information is also ensured. Therefore, efficiency of document reading is improved, and experience of the user is enhanced.

According to some embodiments of the present disclosure, there is also provided a view displaying apparatus.

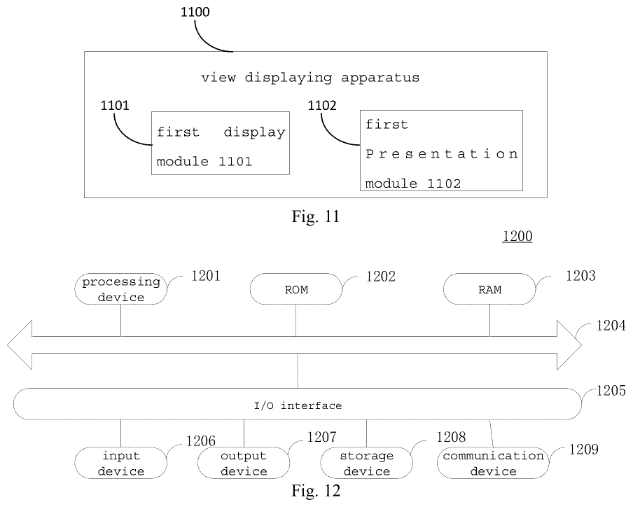

FIG. 11 is a schematic structural diagram of a view displaying apparatus provided in some embodiments of the present disclosure, wherein the apparatus may be implemented by software and/or hardware, and may be generally integrated in an electronic device. As shown in FIG. 11, the view displaying apparatus 1100 comprises: a first display module 1101 configured to display a content area and a view area in a document interface, wherein the view area is used for displaying one or more pieces of view information; and a first presentation module 1102 configured to, in response to a browse triggering operation on view information in the view area, present the view information in the view area in a first browse direction, wherein the content area corresponds to a second browse direction different from the first browse direction.

Alternatively, the apparatus further comprises: a first portrait-screen matching module configured to, in response to portrait-screen viewing of the document interface, match a number of pieces of the view information displayed in the view area with a portrait-screen displaying size of the view area; and a first landscape-screen matching module configured to, in response to landscape-screen viewing of the document interface, match a number of pieces of the view information displayed in the view area with a landscape-screen displaying size of the view area.

Alternatively, the first displaying module 1102 is configured to: in response to a leftward/rightward swipe browsing operation on the view information in the view area, leftward/rightward swipe in the view area, to display rest view information in the view.

Alternatively, the first displaying module 1102 is configured to: in response to a triggering operation on a browse control of the view information in the view area, update and display, in the view area the rest view information in the view.

Alternatively, the apparatus further comprises: a first adjustment module configured to, in response to a triggering operation on a control in the view area, adjust the first browse direction of the view information to the second browse direction, and/or adjust layout information of the view information from first layout information to second layout information, the layout information comprising at least one of a position relation between the pieces of view information or a position relation between the pieces of view information and the control.

Alternatively, the apparatus further comprises: a second displaying module configured to, in response to a zoom-in triggering operation on the view information in the view area, display, in a full-screen area, the one or more pieces of view information in the view.

Alternatively, the zoom-in triggering operation on the view information in the view area comprises: performing a triggering operation on a zoom-in control associated with the view area in the document interface; or performing a double-click operation on the view area.

Alternatively, the apparatus comprises: a second portrait-screen matching module configured to, in response to portrait-screen viewing of the document interface, match a number of pieces of the view information displayed in the full-screen area with the portrait-screen displaying size; and a second landscape-screen matching module configured to, in response to landscape-screen viewing of the document interface, match a number of pieces of the view information displayed in the full-screen area with the landscape-screen displaying size.

Alternatively, the apparatus further comprises: the second displaying module configured to, in response to a browse triggering operation on the view information in the full-screen area, display the view information in the full-screen area in the second browse direction.

Alternatively, the second displaying module is configured to: in response to an upward/downward swipe browsing operation on the view information in the full-screen area, upward/downward swipe in the full-screen area to display rest view information in the view.

Alternatively, the second displaying module is configured to: in response to a triggering operation on a browse control of the view information in the full-screen area, update and display, in the full-screen area the rest view information in the view.

Alternatively, the apparatus further comprises: a second adjustment module configured to, in response to a triggering operation on a control in the full-screen area, adjust the second browse direction of the view information to the first browse direction, and/or adjust a key content of the view information from first displaying information to second displaying information, the key content comprising at least one of an image content of the view information or a text content of the view information.

Alternatively, the apparatus further comprises: a function triggering module configured to, in response to a viewing operation on target view information, perform full-screen display on the target view information, and in response to a triggering operation on a target function entry on the target view information, start the target function.

The view displaying apparatus provided in the embodiments of the present disclosure can perform the view displaying method provided in any embodiment of the present disclosure, and has corresponding functional modules for performing the method and beneficial effects.

In some embodiments of the present disclosure, there is further provided a computer program product, comprising a computer program/instruction which, when executed by a processor, implements the view displaying method provided in any embodiment of the present disclosure.

FIG. 12 is a schematic structural diagram of an electronic device provided in some embodiments of the present disclosure.

Reference is specifically made below to FIG. 12, which shows a schematic structural diagram of an electronic device 1200 suitable for implementing some embodiments of the present disclosure. The electronic device 1200 in the embodiments of the present disclosure may include, but is not limited to, mobile terminals such as a mobile phone, a notebook computer, a digital broadcast receiver, a PDA (Personal Digital Assistant), a PAD (tablet computer), a PMP (Portable Multimedia Player), and a vehicle-mounted terminal (e.g., a vehicle-mounted navigation terminal), and fixed terminals such as a digital TV, and a desktop computer. The electronic device shown in FIG. 12 is only an example, and should not bring any limitation to the functions and the scope of use of the embodiments of the present disclosure.

As shown in FIG. 12, the electronic device 1200 may comprise a processing device (e.g., a central processing unit, graphics processing unit, etc.) 1201, which may perform various appropriate actions and processes according to a program stored in a read-only memory (ROM) 1202 or a program loaded from a storage device 1208 into a random access memory (RAM) 1203. In the RAM 1203, various programs and data necessary for the operation of the electronic device 1200 are also stored. The processing device 1201, the ROM 1202, and the RAM 1203 are connected to each other via a bus 1204. An input/output (I/O) interface 1205 is also connected to the bus 1204.

Generally, the following devices may be connected to the I/O interface 1205: an input device 1206 including, for example, a touch screen, touch pad, keyboard, mouse, camera, microphone, accelerometer, gyroscope, etc.; an output device 1207 including, for example, a liquid crystal display (LCD), speaker, vibrator, etc.; the storage device 1208 including, for example, a magnetic tape, hard disk, etc.; and a communication device 1209. The communication device 1209 may allow the electronic device 1200 to communicate wirelessly or by wire with other devices to exchange data. While FIG. 12 illustrates the electronic device 1200 having various devices, it should be understood that not all illustrated devices are required to be implemented or provided. More or less devices may be alternatively implemented or provided.

In particular, according to some embodiments of the present disclosure, the process described above with reference to the flow diagram may be implemented as a computer software program. For example, the embodiments of the present disclosure comprises a computer program product which comprises a computer program carried on a non-transitory computer-readable medium, the computer program containing program code for performing the method illustrated by the flow diagram. In such an embodiment, the computer program may be downloaded from a network through the communication device 1209 and installed, or installed from the storage device 1208, or installed from the ROM 1202. The computer program, when executed by the processing device 1201, performs the above functions defined in the view displaying method of the embodiments of the present disclosure.

It should be noted that the above non-transitory computer-readable medium of the present disclosure may be a computer-readable signal medium or a computer-readable storage medium or any combination of the two. The computer-readable storage medium may be, for example, but not limited to, an electronic, magnetic, optical, electromagnetic, infrared, or semiconductor system, apparatus, or device, or any combination of the above. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium containing or storing a program which can be used by or in conjunction with an instruction execution system, apparatus, or device. Moreover, in the present disclosure, the computer-readable signal medium may include a data signal propagated in baseband or as part of a carrier wave, in which computer-readable program code is carried. Such a propagated data signal may take a variety of forms, including, but not limited to, electromagnetic signals, optical signals, or any suitable combination of the above. The computer-readable signal medium may also be any computer-readable medium other than the computer-readable storage medium, which can send, propagate, or transmit a program for use by or in conjunction with an instruction execution system, apparatus, or device. The program code contained on the computer-readable medium may be transmitted using any appropriate medium, including but not limited to: wires, optical cables, RF (radio frequency), etc., or any suitable combination of the above.

In some implementations, a client and server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be contained in the above electronic device; or may exist separately without being assembled into the electronic device.

The above computer-readable medium has thereon carried one or more programs which, when executed by the electronic device, cause the electronic device to: display, in a view area in a document interface, one or more pieces of view information in a view; and in response to a browse triggering operation on view information in the view area, display, in the view area, rest view information in the view. In the embodiments of the present disclosure, the view information in the view is displayed in the view area, so that the view information occupying too much space of the document interface is avoided, and the user is enabled to view the context of the document while browsing the view information, and the user can browse the rest view information of the view through the triggering operation, so that convenience of viewing the document by the user is improved and integrity of the information is also ensured.

Computer program code for performing operations of the present disclosure may be written in one or more programming languages or a combination thereof. The above programming language includes, but is not limited to, an object-oriented programming language such as Java, Smalltalk, and C++, and further includes a conventional procedural programming language such as the “C” language or a similar programming language. The program code may be executed entirely on a user's computer, partly on the user's computer, as a stand-alone software package, partly on the user's computer and partly on a remote computer, or entirely on the remote computer or server. In a scenario where the remote computer is involved, the remote computer may be connected to the user's computer through any type of network, including a local area network (LAN) or a wide area network (WAN), or connected to an external computer (for example, through the Internet using an Internet service provider).

The flow diagrams and block diagrams in the drawings illustrate the possibly implemented architecture, functions, and operations of the systems, methods and computer program products according to various embodiments of the present disclosure. In this regard, each block in the flow diagram or block diagram may represent one module, program segment, or part of code, which contains one or more executable instructions for implementing specified logical functions. It should also be noted that, in some alternative implementations, the functions noted in the blocks may also occur in a different order from those noted in the drawings. For example, two blocks shown in succession may, in fact, be executed substantially concurrently, and they may sometimes be executed in a reverse order, which depends upon functions involved. It will also be noted that each block of the block diagrams and/or flow diagrams, and a combination of blocks in the block diagrams and/or flow diagrams, can be implemented by a special-purpose hardware-based system that performs the specified functions or operations, or a combination of special-purpose hardware and computer instructions.

The involved units described in the embodiments of the present disclosure may be implemented by software or hardware. The name of the unit, in some cases, does not constitute a limitation on the unit itself.

The functions described above herein may be at least partially executed by one or more hardware logic components. For example, without limitation, an exemplary type of hardware logic components that may be used includes: a field programmable gate array (FPGA), application specific integrated circuit (ASIC), application specific standard product (ASSP), system on a chip (SOC), complex programmable logic device (CPLD), and the like.

In the context of this disclosure, a machine-readable medium may be a tangible medium, which may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

According to one or more embodiments of the present disclosure, there is provided a view displaying method comprising: displaying a content area and a view area in a document interface, wherein the view area is used for displaying one or more pieces of view information; and in response to a browse triggering operation on view information in the view area, displaying the view information in the view area in a first browse direction, wherein the content area corresponds to a second browse direction different from the first browse direction.

According to one or more embodiments of the present disclosure, the view displaying method provided in the present disclosure comprises: in response to portrait-screen viewing of the document interface, matching a number of pieces of the view information displayed in the view area with a portrait-screen displaying size of the view area; and in response to landscape-screen viewing of the document interface, matching a number of pieces of the view information displayed in the view area with a landscape-screen displaying size of the view area.

According to one or more embodiments of the present disclosure, in the view displaying method provided in the present disclosure, the in response to a browse triggering operation on view information in the view area, displaying in the view area, rest view information in the view, comprises: in response to a leftward/rightward swipe browsing operation on the view information in the view area, leftward/rightward swiping in the view area to display the rest view information in the view.

According to one or more embodiments of the present disclosure, in the view displaying method provided in the present disclosure, the in response to a browse triggering operation on view information in the view area, displaying in the view area, rest view information in the view, comprises: in response to a triggering operation on a browse control of the view information in the view area, updating and displaying, in the view area, rest view information in the view.

According to one or more embodiments of the present disclosure, the view displaying method provided in the present disclosure further comprises: in response to a triggering operation on a control in the view area, adjusting the first browse direction of the view information to the second browse direction, and/or adjusting layout information of the view information from first layout information to second layout information, the layout information comprising at least one of a position relation between the pieces of view information or a position relation between the pieces of view information and the control.

According to one or more embodiments of the present disclosure, the view displaying method provided in the present disclosure further comprises: in response to a zoom-in triggering operation on the view information in the view area, displaying, in a full-screen area, the one or more pieces of view information in the view.

According to one or more embodiments of the present disclosure, the view displaying method provided in the present disclosure comprises: performing a triggering operation on a zoom-in control associated with the view area in the document interface; or performing a double-click operation on the view area.

According to one or more embodiments of the present disclosure, the view displaying method provided in the present disclosure comprises: in response to portrait-screen viewing of the document interface, matching a number of pieces of the view information displayed in the full-screen area with the portrait-screen displaying size; and in response to landscape-screen viewing of the document interface, matching a number of pieces of the view information displayed in the full-screen area with the landscape-screen displaying size.

According to one or more embodiments of the present disclosure, the view displaying method provided in the present disclosure further comprises: in response to a browse triggering operation on the view information in the full-screen area, displaying the view information in the full-screen area in the second browse direction.

According to one or more embodiments of the present disclosure, in the view displaying method provided in the present disclosure, the in response to a browse triggering operation on the view information in the full-screen area, displaying in the full-screen area, rest view information in the view, comprises: in response to an upward/downward swipe browsing operation on the view information in the full-screen area, upward/downward swiping in the full-screen area to display the rest view information in the view.

According to one or more embodiments of the present disclosure, in the view displaying method provided in the present disclosure, the in response to a browse triggering operation on the view information in the full-screen area, displaying in the full-screen area, rest view information in the view, comprises: in response to a triggering operation on a browse control of the view information in the full-screen area, update and display, in the full-screen area, the rest view information in the view.

According to one or more embodiments of the present disclosure, the view displaying method provided in the present disclosure further comprises: in response to a triggering operation on a control in the full-screen area, adjusting the second browse direction of the view information to the first browse direction, and/or adjusting a key content of the view information from first displaying information to second displaying information, the key content comprising at least one of an image content of the view information or a text content of the view information.

According to one or more embodiments of the present disclosure, the view displaying method provided in the present disclosure further comprises: in response to a viewing operation on target view information, performing full-screen display on the target view information; and in response to a triggering operation on a target function entry on the target view information, starting the target function.

According to one or more embodiments of the present disclosure, there is provided a view displaying apparatus, comprising: a first display module configured to display a content area and a view area in a document interface, wherein the view area is used for displaying one or more pieces of view information; and a first presentation module configured to, in response to a browse triggering operation on view information in the view area, present the view information in the view area in a first browse direction, wherein the content area corresponds to a second browse direction different from the first browse direction.

According to one or more embodiments of the present disclosure, the view displaying apparatus provided in the present disclosure, further comprises: a first portrait-screen matching module configured to, in response to portrait-screen viewing of the document interface, match a number of pieces of the view information displayed in the view area with a portrait-screen displaying size of the view area; a first landscape-screen matching module configured to, in response to landscape-screen viewing of the document interface, match a number of pieces of the view information displayed in the view area with a landscape-screen displaying size of the view area.

According to one or more embodiments of the present disclosure, in the view displaying apparatus provided in the present disclosure, the first displaying module is configured to: in response to a leftward/rightward swipe browsing operation on the view information in the view area, leftward/rightward swipe in the view area to display rest view information in the view.

According to one or more embodiments of the present disclosure, in the view displaying apparatus provided in the present disclosure, the first displaying module is configured to: in response to a triggering operation on a browse control of the view information in the view area, update and display, in the view area, rest view information in the view.

According to one or more embodiments of the present disclosure, the view displaying apparatus provided in the present disclosure, further comprises: a first adjustment module configured to, in response to a triggering operation on a control in the view area, adjust the first browse direction of the view information to the second browse direction, and/or adjust layout information of the view information from first layout information to second layout information, the layout information comprising at least one of a position relation between the pieces of view information or a position relation between the pieces of view information and the control.

According to one or more embodiments of the present disclosure, the view displaying apparatus provided in the present disclosure, further comprises: a second displaying module configured to, in response to a zoom-in triggering operation on the view information in the view area, display, in a full-screen area, the one or more pieces of view information in the view.

According to one or more embodiments of the present disclosure, in the view displaying apparatus provided in the present disclosure, the zoom-in triggering operation on the view information in the view area comprises: performing a triggering operation on a zoom-in control associated with the view area in the document interface; or performing a double-click operation on the view area.

According to one or more embodiments of the present disclosure, the view displaying apparatus provided in the present disclosure, comprises: a second portrait-screen matching module configured to, in response to portrait-screen viewing of the document interface, match a number of pieces of the view information displayed in the full-screen area with the portrait-screen displaying size; a second landscape-screen matching module configured to, in response to landscape-screen viewing of the document interface, match a number of pieces of the view information displayed in the full-screen area with the landscape-screen displaying size.

According to one or more embodiments of the present disclosure, the view displaying apparatus provided in the present disclosure, further comprises: the second displaying module configured to, in response to a browse triggering operation on the view information in the full-screen area, display the view information in the full-screen area in the second browse direction. According to one or more embodiments of the present disclosure, in the view displaying apparatus provided in the present disclosure, the second displaying module is configured to: in response to an upward/downward swipe browsing operation on the view information in the full-screen area, upward/downward swipe in the full-screen area to display rest view information in the view.

According to one or more embodiments of the present disclosure, in the view displaying apparatus provided in the present disclosure, the second displaying module is configured to: in response to a triggering operation on a browse control of the view information in the full-screen area, update and display, in the full-screen area, the rest view information in the view.

According to one or more embodiments of the present disclosure, the view displaying apparatus provided in the present disclosure, further comprises: a second adjustment module configured to, in response to a triggering operation on a control in the full-screen area, adjust the second browse direction of the view information to the first browse direction, and/or adjust a key content of the view information from first displaying information to second displaying information, the key content comprising at least one of an image content of the view information or a text content of the view information.

According to one or more embodiments of the present disclosure, the view displaying apparatus provided in the present disclosure, further comprises: a function triggering module configured to, in response to a viewing operation on target view information, perform full-screen display on the target view information, and in response to a triggering operation on a target function entry on the target view information, start the target function.

The modules described above may be implemented as software components executed on one or more general-purpose processors, or as hardware executing certain functions or combinations thereof, such as a programmable logic device and/or application specific integrated circuit. In some embodiments, these modules may be embodied in a form of software product that may be stored in non-volatile storage media including instructions that cause a computer device (e.g., a personal computer, server, network device, mobile terminal, etc.) to implement the method described in the embodiments of the present disclosure. In other embodiments, the above modules may also be implemented on a single device or may be distributed on a plurality of devices. Functions of these modules may be combined with each other, or further divided into a plurality of sub-modules.

According to one or more embodiments of the present disclosure, there is provided an electronic device, comprising: a processor; and a memory configured to store executable instructions for the processor, the processor being configured to read the executable instructions from the memory and execute the instructions to implement any of the view displaying methods provided in the present disclosure.

According to one or more embodiments of the present disclosure, there is provided a computer-readable storage medium having thereon stored a computer program, for performing any of the view displaying methods provided in the present disclosure.

According to one or more embodiments of the present disclosure, there is provided a computer program comprising instructions which, when executed by a processor, cause the processor to perform the above view displaying method.

The foregoing description is only illustrations of preferred embodiments of the present disclosure and the technical principles employed. It should be appreciated by those skilled in the art that the scope involved in the present disclosure is not limited to the technical solutions formed by specific combinations of the technical features described above, but also encompasses other technical solutions formed by arbitrary combinations of the above technical features or equivalent features thereof without departing from the above disclosed concepts. For example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Conversely, the specific features and actions described above are only example forms of implementing the claims.

1. A view displaying method, comprising:
displaying a content area and a view area in a document interface, wherein the view area is used for displaying one or more pieces of view information; and
in response to a browse triggering operation on view information in the view area, displaying the view information in the view area in a first browse direction, wherein the content area corresponds to a second browse direction different from the first browse direction.

2. The view displaying method according to claim 1, wherein:
in response to portrait-screen viewing of the document interface, a number of pieces of the view information displayed in the view area is matched with a portrait-screen displaying size of the view area; and
in response to landscape-screen viewing of the document interface, a number of pieces of the view information displayed in the view area is matched with a landscape-screen displaying size of the view area.

3. The view displaying method according to claim 1, wherein in response to the browse triggering operation on the view information in the view area, the displaying the view information in the view area in the first browse direction, comprises:
in response to a leftward/rightward swipe browsing operation on the view information in the view area, leftward/rightward swiping in the view area to display rest view information.

4. The view displaying method according to claim 1, wherein in response to the browse triggering operation on the view information in the view area, displaying the view information in the view area in the first browse direction, comprises:
in response to a triggering operation on a browse control of the view information in the view area, updating and displaying, in the view area, rest view information in the view.

5. The view displaying method according to claim 1, further comprising:
in response to a triggering operation on a control in the view area, adjusting the first browse direction of the view information to the second browse direction, and/or adjusting layout information of the view information from first layout information to second layout information, the layout information comprising at least one of a position relation between the pieces of view information or a position relation between the pieces of view information and the control.

6. The view displaying method according to claim 1, further comprising:
in response to a zoom-in triggering operation on the view information in the view area, displaying, in a full-screen area, the one or more pieces of view information.

7. The view displaying method according to claim 6, wherein the zoom-in triggering operation on the view information in the view area comprises:
a triggering operation on a zoom-in control associated with the view area in the document interface; or
a double-click operation on the view area.

8. The view displaying method according to claim 6, wherein in response to the zoom-in triggering operation on the view information in the view area, the displaying, in the full-screen area, the one or more pieces of view information, comprises:
in response to portrait-screen viewing of the document interface, matching a number of pieces of the view information displayed in the full-screen area with the portrait-screen displaying size; and
in response to landscape-screen viewing of the document interface, matching a number of pieces of the view information displayed in the full-screen area with the landscape-screen displaying size.

9. The view displaying method according to claim 6, further comprising:
in response to a browse triggering operation on the view information in the full-screen area, displaying the view information in the full-screen area in the second browse direction.

10. The view displaying method according to claim 9, wherein in response to the browse triggering operation on the view information in the full-screen area, the displaying the view information in the full-screen area in the second browse direction, comprises:
in response to an upward/downward swipe browsing operation on the view information in the full-screen area, upward/downward swiping in the full-screen area to display rest view information.

11. The view displaying method according to claim 9, wherein in response to the browse triggering operation on the view information in the full-screen area, the displaying the view information in the full-screen area in the second browse direction, comprises:
in response to a triggering operation on a browse control of the view information in the full-screen area, updating and displaying, in the full-screen area, rest view information.

12. The view displaying method according to claim 1, further comprising:
in response to a triggering operation on a control in the full-screen area, adjusting the second browse direction of the view information to the first browse direction, and/or adjusting a key content of the view information from first displaying information to second displaying information, the key content comprising at least one of an image content of the view information or a text content of the view information.

13. The view displaying method according to claim 1, further comprising:
in response to a viewing operation on target view information, performing full-screen display on the target view information; and
in response to a triggering operation on a target function entry on the target view information, starting the target function.

14. The view displaying method according to claim 1, wherein in response to the browse triggering operation on view information in the view area, the displaying the view information in the view area in the first browse direction, comprises:
determining a number of pieces of the view information displayed in the view area according to a viewing direction of a screen.

15. (canceled)

16. An electronic device, comprising:
a processor; and
a memory configured to store executable instructions for the processor, wherein the processor is configured to read the executable instructions from the memory and execute the instructions to implement a view displaying method comprising:
displaying a content area and a view area in a document interface, wherein the view area is used for displaying one or more pieces of view information; and
in response to a browse triggering operation on view information in the view area, displaying the view information in the view area in a first browse direction, wherein the content area corresponds to a second browse direction different from the first browse direction.

17. A non-transitory computer-readable storage medium having therein stored instructions which, when running on a terminal device, cause the terminal device to implement a view displaying method comprising:
displaying a content area and a view area in a document interface, wherein the view area is used for displaying one or more pieces of view information; and
in response to a browse triggering operation on view information in the view area, displaying the view information in the view area in a first browse direction, wherein the content area corresponds to a second browse direction different from the first browse direction.

18. (canceled)

19. (canceled)

20. The electronic device according to claim 16, wherein:
in response to portrait-screen viewing of the document interface, a number of pieces of the view information displayed in the view area is matched with a portrait-screen displaying size of the view area; and
in response to landscape-screen viewing of the document interface, a number of pieces of the view information displayed in the view area is matched with a landscape-screen displaying size of the view area.

21. The electronic device according to claim 16, wherein the view displaying method further comprises:
in response to a leftward/rightward swipe browsing operation on the view information in the view area, leftward/rightward swiping in the view area to display rest view information.

22. The non-transitory computer-readable storage medium according to claim 17, wherein:
in response to portrait-screen viewing of the document interface, a number of pieces of the view information displayed in the view area is matched with a portrait-screen displaying size of the view area; and
in response to landscape-screen viewing of the document interface, a number of pieces of the view information displayed in the view area is matched with a landscape-screen displaying size of the view area.

23. The non-transitory computer-readable storage medium according to claim 17, wherein the view displaying method further comprises:
in response to a leftward/rightward swipe browsing operation on the view information in the view area, leftward/rightward swiping in the view area to display rest view information.
